(19) United States
(12) Patent Application Publication
(10) Pub. No.: US 2016/0098162 A1
(43) Pub. Date: Apr. 7, 2016

(54) PEN BASED LOCKING MECHANISM

(71) Applicant: Lenovo (Singapore) Pte. Ltd., Singapore (SG)

(72) Inventors: Ming Qian, Cary, NC (US); Jian Li, Chapel Hill, NC (US); Bradley Park Strazisar, Cary, NC (US); Song Erin Wang, Cary, NC (US); Geoffrey Simon Bula, Apex, NC (US); Antoine Roland Raux, Cupertino, CA (US)

(21) Appl. No.: 14/507,093

(22) Filed: Oct. 6, 2014

(51) Int. Cl. G06F 3/0483; G06F 3/0354; H04L 29/08; G06F 3/0484

(52) U.S. Cl. CPC G06F 3/0483; G06F 3/04847; G06F 3/03545; H04L 67/10

(57) ABSTRACT

A method includes tracking pointing device interaction with a multi-user page via a pointing device, identifying a portion of the multi-user page via the interaction, and establishing an exclusive access zone corresponding to the identified portion for the user as a function of the tracked pointing device interaction.

### BACKGROUND

Multiple users may want to edit a note page simultaneously. A user may lock a page such that no other users can modify the page at the same time. Locking an entire page precludes other users from modifying the page until the user unlocks the page.

### SUMMARY

A method includes tracking pointing device interaction with a multi-user page, identifying a portion of the multi-user page via the interaction, and establishing an exclusive access zone corresponding to the identified portion for the user as a function of the tracked pointing device interaction.

A machine readable storage device has instructions for execution by a processor of a machine, the instruction comprising instructions to perform tracking pointing device interaction with a multi-user page, identifying a portion of the multi-user page via the interaction, and establishing an exclusive access zone corresponding to the identified portion for the user as a function of the tracked pointing device interaction.

A device includes a processor and a memory device having a program stored thereon for execution by the processor to track pointing device interaction with a multi-user page via a pointing device, identify a portion of the multi-user page via the interaction, and establish an exclusive access zone corresponding to the identified portion for the user as a function of the tracked pointing device interaction.

### BRIEF DESCRIPTION OF THE DRAWINGS

FIG. 1 is a block diagram of a page sharing system according to an example embodiment.

FIG. 2 is a representation of a shared page having content and user locked zones according to an example embodiment.

FIG. 3 is a perspective diagram of a pen interacting with a device showing a shared page according to an example embodiment.

FIG. 4 is a perspective diagram of a pen not interacting with a device showing a shared page according to an example embodiment.

FIG. 5 is a flowchart illustrating a method for locking zones on a shared page for use by respective users according to an example embodiment.

FIG. 6 is a block diagram of computer system architecture used to implement methods and device according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software or a combination of software and human implemented procedures in one embodiment. The software may consist of computer executable instructions stored on computer readable media such as memory or other type of hardware based storage devices, either local or networked. Further, such functions correspond to modules, which are software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system.

In various embodiments, user interactions on a shared page are tracked, with portions being interacted with by the users being locked so only the users interacting with the portions can modify the portions.

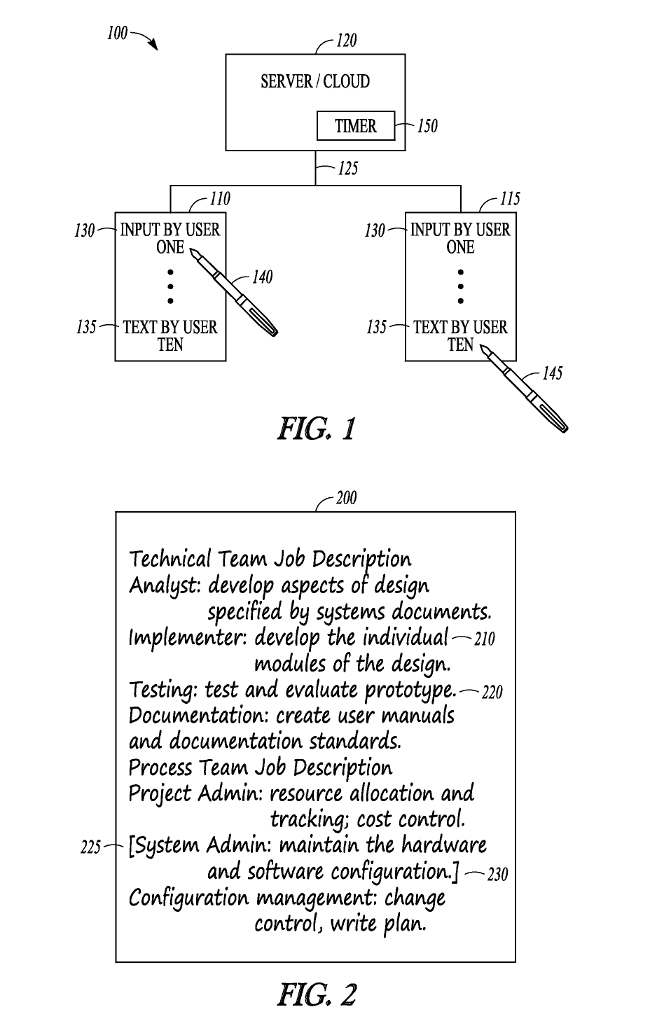

FIG. 1 is a block diagram of a system 100 that facilitates sharing pages with multiple users. Several screen and page sharing systems are currently available, such as SharePoint®, Fuze™, GoToMeeting®, and others. In one embodiment, the shared page may be duplicated for each user on a device 110, 115 of their choosing, such as a screen of a smartphone, tablet, or other device having a display such as a touchscreen. The devices may be coupled to a server or cloud 120 in one embodiment. In further embodiments, the devices themselves may share the pages and provide desired functions without the use of a server 120.

Each user device 110, 115 is illustrated with duplicate content indicated at 130 and 135, corresponding to input, such as text or other drawing content. A writing instrument 140 and 145 are shown being used by different users on respective devices 110, 115 and interacting with different content. A first user may utilize device 110 with instrument 140 to input content 130, while another user, identified as a tenth user may utilize device 115 with instrument 145 to input content 135. Many other users may view and interact with other content on the page. A non-interaction timer 150 may be used to facilitate releasing locked sections or zones as further described below.

A user may interact with a page, such as a touchscreen or electronic paper, also referred to as smart paper via a writing instrument such as a pen. The writing instrument itself may be a smart pen that comprises the device, or may be a simple pencil or pen, or other pointing device, such as a mouse or touchpad, with interactions monitored via the page, sensors, cameras, or other devices.

FIG. 2 is an example of a page 200 that is being viewed and modified by multiple users. First content, indicated as text 210 “Implementer: develop the individual modules of the design” is being interacted with by a first user. The text 210 in one embodiment is imbued with an attribute which may be associated with the first user, such as a color, for example, green. The text 210 remains green while the first user continues to interact with the text. During the interaction, the text 210 may be locked from being modified by other users. In various embodiments, the content may be handwritten notes including text and graphics, may be typed material, voice recognized text, or other content.

A second content indicated as text 220 “Testing: test and evaluate prototype.” is being interacted with by a second user, and may have a second attribute associated with the user, such as the color red. Other users are locked out from interacting with the text 220 while the second user continues to interact with the text 220. Both the first and second users in one embodiment each have the same page displayed on their device in one embodiment, with changes being shown in each page.

A further section or zone of content is shown locked by the use of pen gestures to create one or more gesture created locking indicators, such as brackets 225 and 230. The gesture created locked section may be created using the brackets, or other gesture or pointing device created indicators, such as circling, a single bracket or line at the side of the text, or other gestures. A gesture created locked section or zone may also be created by highlighting the zone using a mouse pointing device in one embodiment. Such gesture locked text may also be released for interaction by other users by using the pen or other pointing device to undo the gestures. In one embodiment, tapping a bracket or circle may remove the bracket or circle or other gesture. The pointing device may also be changed to an erase mode, allowing removal of the gesture created locking identifier.

In some embodiment, locked sections or exclusive access zones may correspond to a sentence, a paragraph, or other block of content which may be automatically identified based on interaction with a sentence or paragraph, and may also be indicated by creating section identifiers such as the brackets or circling described above.

The lock on each section or zone may remain until a user releases it using gestures, or after a set time period of non-interaction with the section by a user. In one example, a multiple second timer may be set. Following expiration of the timer with no interaction by the corresponding user having locked the section, the lock on the section is released. The section may be provided with an attribute indicating that the timer is running, such as blinking, which may increase with speed as the timer approaches zero. The user may reset the timer by touching the section with the pointer or otherwise making changes to the section. The timer may be set to a number of seconds in various embodiments, such as three seconds or more. When the timer expires with no interaction, the attributes of the section associated with the lock may be removed in some embodiments.

In a further embodiment, one user may lock the entire page, with the user having control of the page. So long as the user continues to write or otherwise interact with the page, the user maintains control of the page. If the user stops interacting, the timer may start; releasing the page for others to user after the timer expires. Whoever starts to write first may then have control, locking the page from use by others. In some embodiments, one user may be designated as an owner of the page, and may take back control, or give control to another user at any time.

In still a further mode of operation, multiple persons may be working together on the page. This may be useful in brainstorming sessions with one user writing down ideas. Twin writing may also be performed, and allows multiple people to finish each other's sentences, filling in blank space, solving problems together. In this multiple person mode, the timer may also be used to provide additional control. For brainstorming for example, the non-interaction timer may be set to a very short time to facilitate interactivity, such as one or two seconds or less.

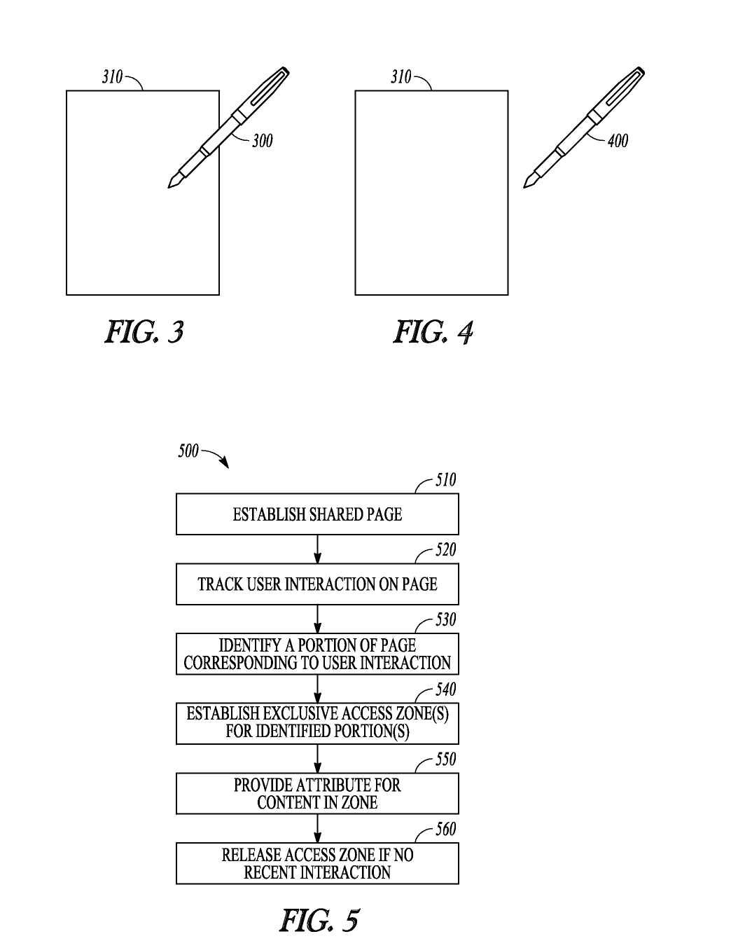

FIG. 3 is a perspective representation of a pen 300 interacting with smart paper 310. The pen 300 in one embodiment is touching, or close to the paper. Close may be defined as the pen being located less than two centimeters or so from the paper, and more likely within a centimeter. The distance of the pen 300 from the paper is indicative of a typical user still desiring to interact with the paper 310, generally thinking of how to further modify the content and having the pen in a position to quickly translate thoughts to actual content modification. Thus, in one embodiment, interacting with the section or zone includes not only actually touching the paper and making changes, but being ready to touch and make changes, providing the user with sole control of the zone or page.

FIG. 4 is a perspective representation of a pen 400 in a different position, outside, up from, or otherwise distanced from the paper 310, indicating a lack of interaction with the paper. Following no writing for a period of time, the page becomes open to other users. In further embodiments, interaction may be defined as actually touching the page. Options for defining interaction may be provided to the user and tailored to specific user working styles. The options may include a distance of the pen from the paper still defined as interacting, time periods for non-interaction, colors or other attributes for identifying locked zones, etc.

FIG. 5 is a flowchart illustrating a method 500 of providing locking functions on a shared page according to an example embodiment. Method 500 may be implemented in a server or cloud, or otherwise distributed to user devices used to show and interact with a page in various embodiments. The user devices may directly or indirection through a server or page owner user device, share locking information to ensure proper operation of locks and user interactions with the page. At 510, a shared page may be established using one or many different page sharing programs. Users may be invited to view and work on the page, with each user seeing a real time view of the page. Changes made by each user may be reflected on all the other pages as soon as possible when each user makes a change.

At 520, interaction by each user with the page may be tracked, and at 530, particular portions of the page, such as sections or zones corresponding to the user interaction are identified. The zones may correspond to sentences, paragraphs, figures, or some other area delineated by pen or pointing device gestures. The zones are correlated to the user interacting with or otherwise defining the zones. At 540, exclusive access for each zone may be established, so that each user interacting with the respective zones may have exclusive access to the zones, locking other users from interaction.

Content in the zones may be provided at 550 with a different attribute, such as a different color, highlighting, underlining, side bar indicator, or other attribute for each user. Further, text bubbles may appear when a pen is held near the text, identifying the user and other information, such as last change, location, time locked, etc.

At 560, zones may be released for interaction with by other users if there has been no recent interaction. The attribute may also be removed. The text bubbles may remain visible as above in some embodiments to see a history of revisions.

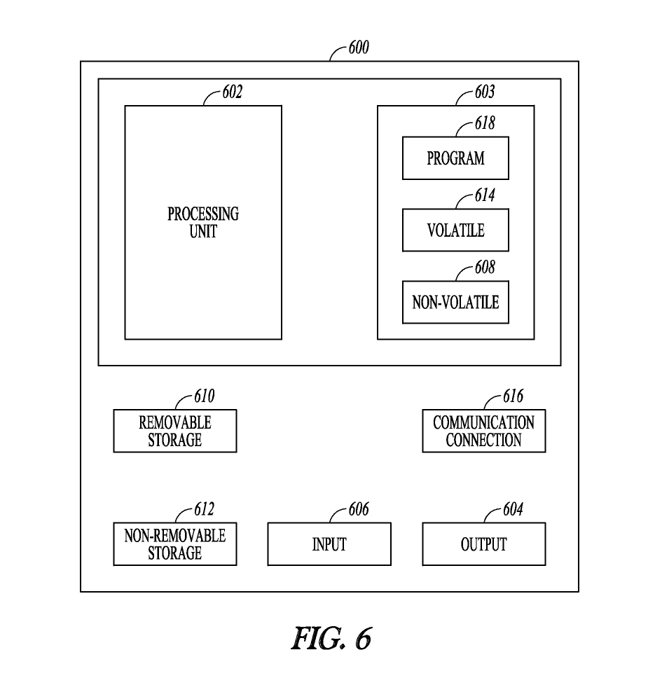

FIG. 6 is a block schematic diagram of a computer system 600 to implement methods according to example embodiments. All components need not be used in various embodiments. One example computing device in the form of a computer 600, may include a processing unit 602, memory 603, removable storage 610, and non-removable storage 612. Although the example computing device is illustrated and described as computer 600, the computing device may be in different forms in different embodiments. For example, the computing device may instead be a smartphone, a tablet, smartwatch, or other computing device including the same or similar elements as illustrated and described with regard to FIG. 6. Devices such as smartphones, tablets, and smartwatches are generally collectively referred to as mobile devices. Further, although the various data storage elements are illustrated as part of the computer 600, the storage may also or alternatively include cloud-based storage accessible via a network, such as the Internet.

Memory 603 may include volatile memory 614 and non-volatile memory 608. Computer 600 may include—or have access to a computing environment that includes—a variety of computer-readable media, such as volatile memory 614 and non-volatile memory 608, removable storage 610 and non-removable storage 612. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 600 may include or have access to a computing environment that includes input 606, output 604, and a communication connection 616. Output 604 may include a display device, such as a touchscreen, that also may serve as an input device. The input 606 may include one or more of a touchscreen, touchpad, mouse, keyboard, camera, one or more device-specific buttons, one or more sensors integrated within or coupled via wired or wireless data connections to the computer 600, and other input devices. The computer may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network (WAN), cellular, WiFi, Bluetooth, or other networks.

Computer-readable instructions stored on a computer-readable medium are executable by the processing unit 602 of the computer 600. A hard drive, CD-ROM, and RAM are some examples of articles including a non-transitory computer-readable medium such as a storage device. The terms computer-readable medium and storage device do not include carrier waves. For example, a computer program 618 capable of providing a generic technique to perform access control check for data access and/or for doing an operation on one of the servers in a component object model (COM) based system may be included on a CD-ROM and loaded from the CD-ROM to a hard drive. The computer-readable instructions allow computer 600 to provide generic access controls in a COM based computer network system having multiple users and servers.

### EXAMPLES

1. A method comprising:

tracking pointer device interaction with a multi-user page;

identifying a portion of the multi-user page via the interaction; and

establishing an exclusive access zone corresponding to the identified portion for the user as a function of the tracked pointing device interaction.

2. The method of example 1 wherein the tracked pointing device interaction comprises interaction with a pen.

3. The method of example 2 wherein the identified portion exclusive access is active while pointing device interaction with the identified portion is detected.

4. The method of example 3 wherein the exclusive access zone is discontinued following a selected period during which no pointing device interaction with the identified portion is detected.

5. The method of example 4 wherein the selected period is three seconds.

6. The method of any of examples 1 wherein the identified portion comprises a paragraph.

7. The method of any of examples 1-6 wherein the identified portion comprises a sentence.

8. The method of any of examples 1-7 wherein the identified portion comprises a portion of the page delineated by the interaction.

9. The method of any of examples 1-8 wherein the tracked pointing device interaction comprises interaction with a pen and wherein the identified portion comprises a portion within brackets identified by the pointer device interaction.

10. The method of any of examples 1-9 and further comprising identifying content in the exclusive access zone with a text attribute visible to multiple users associated with the multi-user page.

11. The method of example 10 wherein the attribute is a color, and wherein multiple exclusive access zones by different users are each identified with a different color.

12. A machine readable storage device having instructions for execution by a processor of a machine, the instruction comprising instructions to perform:

tracking user pointing device interaction with a multi-user page;

identifying a portion of the multi-user page via the interaction; and

establishing an exclusive access zone corresponding to the identified portion for the user as a function of the tracked pointing device interaction.

13. The machine readable storage device of example 12 wherein the pointing device comprises a pen.

14. The machine readable storage device of example 13 wherein the identified portion exclusive access is active while the user interacts with the identified portion.

15. The machine readable storage device of example 14 wherein while the user interacts with the identified portion extends in time a selected period beyond active interaction pen interaction with the identified portion.

16. The machine readable storage device of any of examples 12-15 wherein the identified portion comprises a paragraph.

17. The machine readable storage device of any of examples 12-16 wherein the identified portion comprises a portion of the page delineated by the user.

18. A device comprising:

a processor; and

a memory device having a program stored thereon for execution by the processor to:

track pointing device interaction with a multi-user page via a pointing device;

identify a portion of the multi-user page via the interaction; and

establish an exclusive access zone corresponding to the identified portion for the user as a function of the tracked pointing device interaction.

19. The device of example 18 wherein the pointing device comprises a pen.

20. The device of any of examples 18-19 exclusive access zone is discontinued following a selected period during which no pointing device interaction with the identified portion is detected.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A method comprising:
tracking pointing device interaction with a multi-user page;
identifying a portion of the multi-user page via the interaction; and
establishing an exclusive access zone corresponding to the identified portion for the user as a function of the tracked pointing device interaction.

2. The method of claim 1 wherein the tracked pointing device interaction comprises interaction with a pen.

3. The method of claim 2 wherein the identified portion exclusive access is active while pointing device interaction with the identified portion is detected.

4. The method of claim 3 wherein the exclusive access zone is discontinued following a selected time period during which no pointing device interaction with the identified portion is detected.

5. The method of claim 4 wherein the selected period is three seconds.

6. The method of claim 1 wherein the identified portion comprises a paragraph.

7. The method of claim 1 wherein the identified portion comprises a sentence.

8. The method of claim 1 wherein the identified portion comprises a portion of the page delineated by the interaction.

9. The method of claim 1 wherein the tracked pointing device interaction comprises interaction with a pen and wherein the identified portion comprises a portion within brackets identified by the pointing device interaction.

10. The method of claim 1 and further comprising identifying content in the exclusive access zone with a text attribute visible to multiple users associated with the multi-user page.

11. The method of claim 10 wherein the attribute is a color, and wherein multiple exclusive access zones by different users are each identified with a different color.

12. A machine readable storage device having instructions for execution by a processor of a machine, the instruction comprising instructions to perform:
tracking pointing device interaction with a multi-user page;
identifying a portion of the multi-user page via the interaction; and
establishing an exclusive access zone corresponding to the identified portion for the user as a function of the tracked pointing device interaction.

13. The machine readable storage device of claim 12 wherein the pointing device comprises a pen.

14. The machine readable storage device of claim 13 wherein the identified portion exclusive access is active while the user interacts with the identified portion.

15. The machine readable storage device of claim 14 wherein while the user interacts with the identified portion extends in time a selected period beyond active interaction pen interaction with the identified portion.

16. The machine readable storage device of claim 12 wherein the identified portion comprises a paragraph.

17. The machine readable storage device of claim 12 wherein the identified portion comprises a portion of the page delineated by the user.

18. A device comprising:
a processor; and
a memory device having a program stored thereon for execution by the processor to:
track pointing device interaction with a multi-user page via a pointing device;
identify a portion of the multi-user page via the interaction; and
establish an exclusive access zone corresponding to the identified portion for the user as a function of the tracked pointing device interaction.

19. The device of claim 18 wherein the pointing device comprises a pen.

20. The device of claim 18 wherein the exclusive access zone is discontinued following a selected period during which no pointing device interaction with the identified portion is detected.
